(19) United States
(12) Patent Application Publication
(10) Pub. No.: US 2006/0090826 A1
(43) Pub. Date: May 4, 2006

(54) Protective element for a tread

(75) Inventor: Jose Merino Lopez, Riom (FR)

Correspondence Address: COHEN, PONTANI, LIEBERMAN & PAVANE, 551 FIFTH AVENUE, SUITE 1210, NEW YORK, NY, 10176, US

(73) Assignee: Michelin Recherche et Technique S.A., Granges-Paccot (CH)

(21) Appl. No.: 11/302,805

(22) Filed: Dec. 14, 2005

Related U.S. Application Data
(63) Continuation of application No. PCT/EP04/06334, filed on Jun. 11, 2004.

(30) Foreign Application Priority Data
Jun. 16, 2003 (FR) 03/07232

(51) Int. Cl. B60C 11/01; B60C 11/12; B60C 11/13

(52) U.S. Cl. 152/209.16; 152/209.17; 152/209.22

(57) ABSTRACT

A tread (1) comprising a tread pattern formed of elements in relief (3, 31) defined by grooves (2), at least one of said grooves being oriented in the longitudinal direction of the tread and having a depth H; this tread comprising, axially to the outside of at least one of its edges, at least one element in relief (4), referred to as a “protective element”, having a contact surface (41) which is offset towards the inside of the tread relative to the contact surface (30) of the element(s) in relief (3) which it protects from irregular wear; this element is connected to the protected element (3) by at least one rubber connecting bridge (6) connecting the facing lateral faces (42, 32) of said elements.

### RELATED APPLICATION

This application is a U.S. Continuation Application under 35 USC 371 of International Application PCT/EP2004/006334 filed Jun. 11, 2004.

### FIELD OF INVENTION

The subject of the present invention is an improvement to the tread of tires for heavy vehicles; it relates in particular to treads provided with a tread pattern formed of tread pattern elements essentially in the form of ribs or a combination of blocks and ribs.

This invention is in particular intended to be used for radial-carcass tires intended for the non-driving axles of heavy vehicles.

### BACKGROUND OF INVENTION

Such tires as a general rule comprise a carcass reinforcement surmounted radially to the outside by a crown belt which itself is surmounted by a tread provided with a tread pattern formed essentially of ribs of general circumferential orientation. Furthermore, it is known (U.S. Pat. No. 4,480,671) to provide each of the lateral zones of this tread with a lateral rib axially to the outside of the tread and the meridian profile of which is substantially parallel and radially internal to the meridian profile of the geometric contour forming the geometrical envelope of the principal median zone of the tread.

“Radially inner” is to be understood to mean that when new the lateral rib comprises a face radially to the outside which is offset relative to the running surface of the tire. When passing into contact on the roadway, under the action of the supported load, the material constituting the tread is compressed, which brings the lateral rib into contact with the roadway. The initial offset must be sufficient to create contact pressures on this lateral rib while promoting slip relative to the roadway and thus to develop wear preferentially on this rib, thus protecting the edge rib of the tread from irregular wear. It has been noted that the offset is maintained throughout the period of use of the tread. The average offset used is at least equal to 1 mm and at most equal to 6 mm; this value of the initial offset, that is to say when the tire is new, should of course be adapted according to the nature of the material(s) constituting the tread (rubber mixes) and according to the mechanical properties in compression of these materials.

Due to this arrangement, it is possible to keep a sharp edge (that is to say without rounding) at the edges of the tread, the rib formed axially to the outside of each of said edges acting as what is called a “sacrificed” rib, that is to say a rib, the wear of which will be accentuated in order to reduce the wear of the neighboring edge rib. This sacrificed rib is separated axially from the rib axially furthest to the outside of the tread by a narrow groove of circumferential orientation and of a depth substantially equal to the depth of the main grooves of the tread defining the ribs of said tread.

This structure has completely demonstrated its effectiveness in use; however, it was noted with current conditions of use that when the treads, and more precisely the axially outer edges of these treads, are subjected to impacts during travel, there may result breaks in the rubber mixes at the bottom of the narrow circumferential grooves separating the edge ribs from the sacrificed ribs. To reduce the risk of breaking, it is known to limit the depth of these grooves, but in this case the technical effect sought with the sacrificed rib is not permanent throughout the period of use of the tread.

### SUMMARY OF THE INVENTION

The subject of the invention is a tread the structural characteristics of which make it possible to maintain a sacrificed-rib effect preventing the development of irregular wear on the edges axially to the outside of the tread, this tread itself being provided with a tread pattern formed of a plurality of main grooves of general circumferential orientation defining elements in relief (ribs, blocks). Furthermore, in use, this tread withstands external attack and also [makes it possible to] avoid the formation of breaks in the bottom of the incision.

A tread according to the invention comprises a running surface having two edges and limited axially by lateral faces and a running surface between the two lateral faces, this running surface being intended to come into contact with the ground; this tread comprises, on its running surface, a tread pattern formed of elements in relief (ribs, blocks) defined by grooves, at least one of said grooves being oriented in the longitudinal direction of the tread and having a depth H. This tread comprises, axially to the outside of at least one of its edges, at least one element in relief, referred to as a “protective element” or alternatively “sacrificed element”, having a contact surface which is offset radially towards the inside of the tread relative to the contact surface of the element(s) in relief which it protects from irregular wear; this protective element and the element in relief which it protects have two axially facing lateral faces which define an incision having a depth V substantially equal to the depth H. This tread according to the invention has a protective element which is connected to the tread pattern element protected by a plurality of rubber connecting bridges, these bridges connecting the facing lateral faces of the protected element and of the protective element.

The person skilled in the art will select, as a function of the dimensions of the tread in question and the materials which it comprises, the number of connecting bridges and the surface affected by these bridges in order to retain the protective-rib effect of the element of the edge of the tread while reducing the sensitivity to impacts of the bottom of the incision separating said protective rib from said edge element.

Furthermore, the protective element in relief may be continuous or discontinuous in the longitudinal direction of the tread (that is to say in the circumferential direction once said tread is fitted on a tire). It is of course essential that this continuous protective element or this succession of discontinuous protective elements extend over the entire circumference of the tire in order to protect the entire circumference of the edge element of the tire.

The value of the radial offset of the outer surface of the protective element is selected so as to permit contact between the ground and this surface under conditions of use of a tire fitted with the tread provided with an element. Preferably, this offset is other than zero and greater than 1 mm when new. As explained in U.S. Pat. 4,480,671, the difference in rolling length between the two elements (edge and offset) results in braking forces being created on the offset element and thus makes it possible to concentrate the wear on this element, protecting the edge element from irregular wear. “Braking force” is understood to mean a force exerted by the ground on a tread pattern element, said force opposing the forward movement of the tire.

In the event that the element in relief of at least one edge of a tread is a rib, it is then advisable for the protective element also to be a rib and for the latter to be connected to the edge rib by a plurality of connecting bridges. These bridges are regularly distributed in the longitudinal direction of the tread at different depths so as not to appear on the running surface all at the same time after partial wear.

Preferably, the connecting bridges extend in the direction of the depth of the incision over at least 40% of the depth V of the incision in question.

In the case of a tread comprising a plurality of blocks arranged circumferentially on at least one edge of the tread, it is possible to provide either a continuous rib or a plurality of blocks, the latter possibly being interconnected by other connecting bridges. In all cases, the initial offset between the outer contact surfaces of the protective element and the protected element is selected so that these two surfaces come into contact with the ground during travel as soon as the new tire provided with a tread according to the invention is caused to roll, or even only after relatively short initial use compared with the total duration of use of the tread before being withdrawn for wear.

The bridging surface, that is to say the total of the surfaces of the intersections of the connecting bridges with the lateral surfaces of the protective elements, is determined so as to maintain sufficient flexibility to make it possible for said protective elements to touch the ground during travel.

The use of connecting bridges between protective elements and protected elements of the edge makes it possible to provide incisions of large width while still benefiting from said first elements bearing on the second ones (usually the width of the incision had to be limited in order to obtain this bearing during travel and cornering).

To produce such a tread pattern, known techniques can be used, consisting of molding in the narrow groove separating the protective element from the edge of the tread which it protects, with a material in sheet form having the essential characteristic of withstanding the molding and vulcanization forces of the tread, this sheet having a plurality of orifices to allow the rubber mix to pass through during said molding in order to form connecting bridges connecting the sacrificed element to the edge of the tread.

Another production method consists for example of molding, in conventional manner, the contact surfaces with a slight offset and at the same time molding wells or cavities extending in the direction of the thickness of the tread and regularly spaced in the longitudinal direction. The spaces between these wells are filled with rubber mix during the molding of the tread to form connecting bridges extending from the outer surface of contact of the protective element.

Preferably, each well, of average length D measured in the longitudinal direction of the tread and of average width d measured in the axial or transverse direction of the tread, has a section area of between 1 mm² and 10 mm².

Preferably, the length D of each well measured in the longitudinal direction is between 2.5 mm and 15 mm. It is furthermore preferable for the width d to be smaller than the length D.

If “L” refers to the distance between each well in the circumferential direction, this distance is then preferably between one and six times the dimension D in order to have sufficient connecting stiffness between the protective element and the protected element. Even more preferably, the distance L between each well is between two and four times the average length D of the wells.

The wells may have any sectional geometry and in particular be circular, elliptical, rectangular, triangular, or semi-circular, semi-elliptical or semi-rectangular. To avoid as far as possible a concentration of stresses at certain points during use, it is advisable to use a sectional geometry of the wells, the contour of which does not comprise an angular point (a circular form is preferred to a rectangular form in particular).

In the case of wells having a circular or elliptical section, the average direction of the wells (that is to say the direction of the generatrix of the wells) may be, viewed in a meridian section plane—that is to say one containing the axis of rotation of the tire—perpendicular to the outer surface of the element in relief offset in the initial state or alternatively have an inclination relative to such a perpendicular line. In this latter case, the angle of inclination is preferably less than or equal to 25°. More preferably still, the angle is of between 0° and 15°.

### BRIEF DESCRIPTION OF THE DRAWINGS

Other characteristics and advantages of the invention will become apparent from the description given hereafter with reference to the appended drawings, which show, by way of non-limitative examples, forms of embodiment of the subject of the invention.

FIG. 1 shows a sectional view through an edge of a tire tread according to the invention, the section being taken along the line I-I marked in FIG. 2;

FIG. 2 shows a partial elevation of a tread according to the invention;

FIGS. 3, 4 and 5 show variant arrangements according to the invention;

FIG. 6 shows a variant furthermore comprising channels opening on to the axially outer lateral face of the offset rib;

FIG. 7 shows another variant comprising two incisions separating a protective element from the protected element.

### DESCRIPTION OF THE PREFERRED EMBODIMENTS

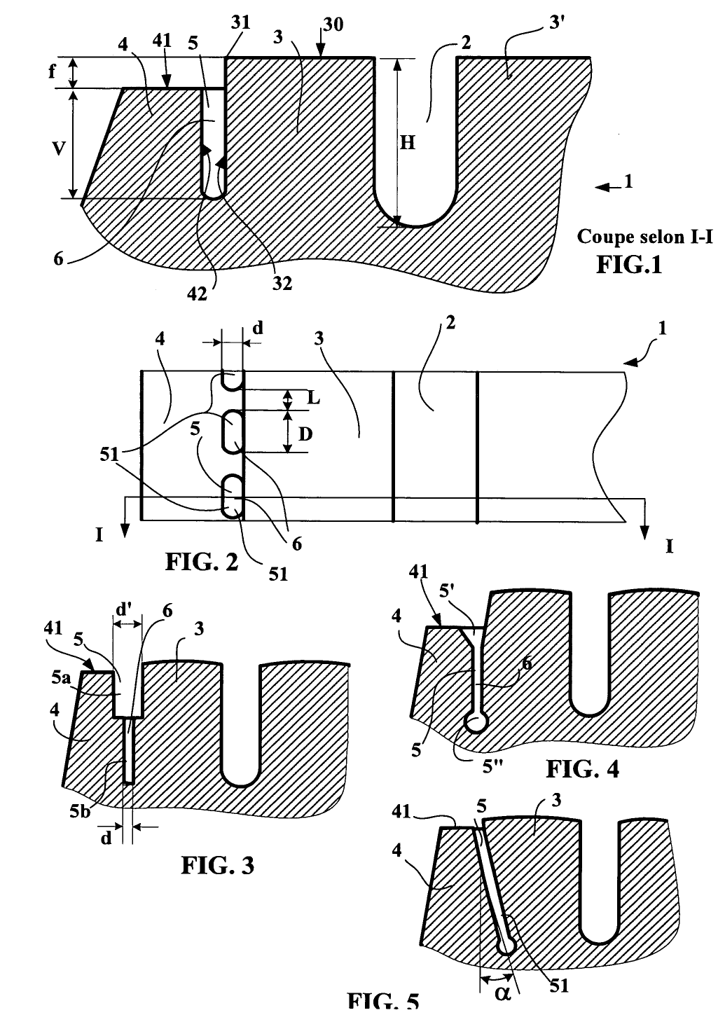

In FIG. 1, there can be seen a partial view of a tread 1 according to the invention. This partial view in section shows an edge rib 3 of the tread 1 separated from another rib 3′ of the tread pattern by a groove 2 of longitudinal orientation of depth H.

In order to protect the outer surface 30 of this edge rib 3 from irregular wear and more particularly from the rounding of its axially outer sharp edge 31, what is called a “protective” rib 4 is arranged axially towards the outside. This protective rib 4 has an external contact surface 41 which is intended to come into contact with the roadway during travel; the difference in the rolling radii measured relative to the axis of rotation of this protective rib 4 and of the edge rib 3 results in amplifying the slip on the protective rib 4, thus bringing about pronounced wear on this rib, reducing the irregular wear on the edge rib 3 accordingly.

This protective rib 4 is offset by a quantity f in the direction of the thickness of the tread and is separated from the edge rib 3 by a narrow incision 5 of depth V (measured relative to the outer surface 41 of the protective rib 4) defined by facing walls 42, 32 (of the protective rib 4 and of the edge rib 3, respectively); these walls 42, 32 are connected by a plurality of connecting bridges 6 of rubber mix as can be seen in FIG. 2, which shows an elevation of the same part of the same tread.

“Narrow incision” is understood here to mean an incision of a width of less than 3 mm.

FIG. 2 shows the narrow incision 5 of width d separating the protective rib 4 from the edge rib 3, this narrow incision 5 comprising a plurality of rubber connecting bridges 6 extending from the contact surface 41 of the protective rib 4 to the bottom of the incision 5. Everything happens as if the incision 5 were formed of a succession of wells 51 of dimensions d and D (the latter dimension being measured in the longitudinal direction of the tread). These wells 51 extend here from the contact surface 41 of the protective rib 4 to the bottom of the incision.

The depth V of each incision or well may be equal to or different from the depth H of the main grooves 2.

Advantageously, the offset f of the radially outer surface 41 of the protective rib 4 is other than zero and such that, under a load equal to the rated load of the tire provided with such a tread, said outer surface 41 is in contact with the roadway on which the tire is running. After contact with the road, the offset of this protective rib 4 is maintained by auto-wear during the entire period of use, the connecting bridges 6 between the protective rib 4 and the edge rib 3 providing a sufficient mechanical connection to avoid breaks in the bottom of the incision 5.

To manufacture such a tread, the plurality of wells can be molded with molding elements of appropriate form and dimensions, these molding elements being placed in relief on the molding surface of a tread mould.

In another embodiment, it is possible, before the molding and vulcanization of the tread, to arrange an insert between the edge rib and the sacrificed rib, said insert being provided with an appropriate number of holes to allow the rubber mix to pass through during the molding operation for the tread and thus form the desired number of connecting bridges and their distribution. The insert is selected to be made from a material which permits molding and can either be removed in its entirety or in part after the molding or gradually be eliminated during rolling.

In one example of embodiment of a tread for a tire of dimension 295/80 R 22.5, the dimensions selected are:
d=2 mm
D=3 mm
L=7 mm (L being the length of the connecting bridges measured in the circumferential direction).

In a desire for simplification and clarity, in the figures below, the elements of the same nature are designated by the same references.

In FIG. 3, another embodiment of a tread according to the invention is shown. In this case, the groove 5 separating the protective element 4 from an edge rib 3 comprises a first part 5a, forming a longitudinal groove of depth h, extended by a second part 5b; the first part 5a opening on to the contact surface 41 of the sacrificed element 4 does not comprise a connecting bridge, and the second part 5b is similar to what has been described for the variant described with the support of FIGS. 1 and 2 and comprises a plurality of connecting bridges 6. The first part 5a of the decoupling groove 5 has a width d′ greater than the width d of the second part of the decoupling groove.

In this manner, it is possible to retain greater transverse mobility of the edge rib when the tread is new and to protect the bottom of the decoupling groove.

In FIG. 4, each well 6 ends, close to the outer surface 41 of the protective element 4 and at the bottom of the incision 5, in parts of substantially larger section 5′ and 5″ respectively, to reduce the concentrations of forces in these parts. Preferably, the section surfaces of the parts of larger section 5′ and 5″ are at most equal to 2.5 times the surface of the incision 5.

The variant of FIG. 5 shows a protective element 4 separated from an edge element 3 by an incision 5 which is in fact formed of a succession of wells 51 located in radial planes, that is to say ones passing through the axis of rotation of the tire, and inclined at an average angle a from a line perpendicular to the contact surface 41 of the sacrificed element 4. Preferably, this average angle a is at most equal to 15°.

The latter arrangement makes it possible better to control the forces in the contact area.

The variant of FIG. 6 shows a combination of the variant described with the support of FIG. 3 and the presence of channels 7 opening on to the lateral face 43 axially to the outside of the protective rib 4. This combination offers the advantage of permitting a very substantial reduction in the operating temperatures in the protective rib 4 and the edge of the tread. In this variant, each channel 7 has a substantially circular section and is connected to at least one well 6; furthermore, each channel 7 is extended into the circumferential groove 2 axially to the inside of the edge rib 3. The offset f of the contact surface 41 of the protective element 4 is preferably selected so that this surface is in contact with the ground when new or if need be after initial wear.

Advantageously, the average section of the channels is circular and has a diameter of between 1.5 mm and 3 mm.

To manufacture such a tread, one or the other of the methods already mentioned further above may be used in combination with the molding of the channels by fingers transverse to the tread, such as, for example, described in Patent WO98/54009.

The invention is not limited to the examples described and shown, and various modifications can be made thereto without departing from the scope thereof.

In particular, the longitudinal ribs (that is to say, the ones which are circumferential on the tire) in the examples described are rectilinear but they may have a zigzag form. Furthermore, the same advantages are obtained when the tread pattern elements of the edges of the tread are blocks possibly interconnected in the circumferential direction by connecting bridges. The protective part may also be formed with a plurality of blocks separated from the adjacent elements of the tread which they protect by incisions provided or not provided with connecting bridges.

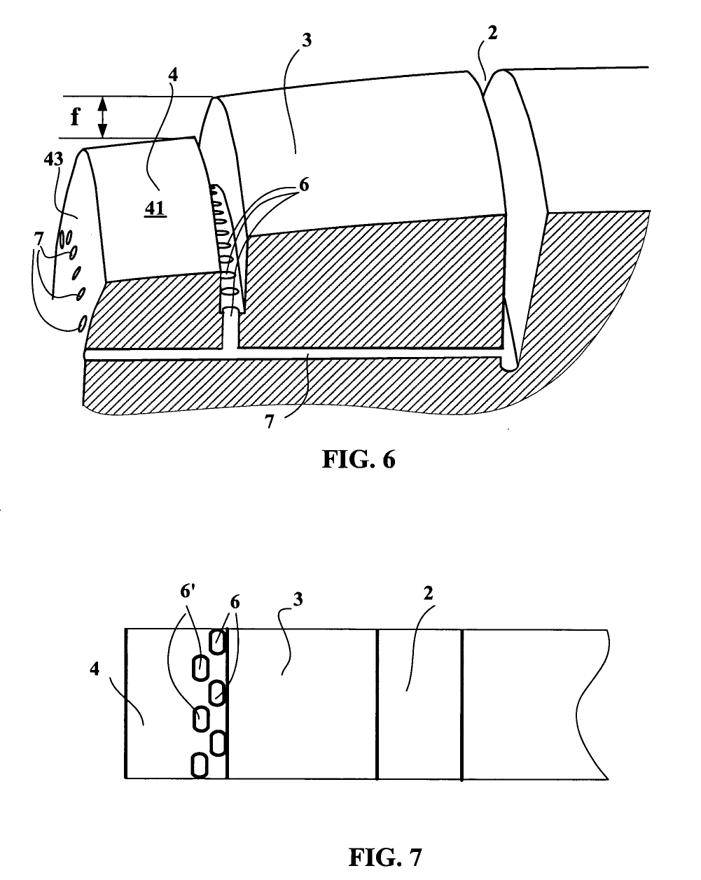

In another form of embodiment (shown in FIG. 7), the protective rib 4 is decoupled from the edge rib 3 by two alignments of wells 6, 6′ which are axially close to each other and to the edge rib and such that the wells 6′ of one series are offset circumferentially from the wells 6 of the other series. This form of embodiment increases the loading flexibility to permit sliding contact of the protective element 4 with the roadway. In this type of variant, it can be conceived that the wells 6 and 6′ have substantially the same depth or alternatively different depths.

The incision or the wells of the variants described may be of non-constant width d and increase towards the bottom of said incision.

What is claimed is:

1- A tread comprising a running surface having two edges and limited axially by lateral faces and a running surface between the two lateral faces, this running surface being intended to come into contact with the ground; this tread comprising, on its running surface, a tread pattern formed of elements in relief defined by grooves, at least one of said grooves being oriented in the longitudinal direction of the tread and having a depth H; this tread comprising, axially to the outside of at least one of its edges, at least one element in relief, referred to as a “protective element”, having a contact surface which is offset radially towards the inside of the tread relative to the contact surface of the element(s) in relief which it protects from irregular wear, the offset being such that its contact surface contacts the road; this protective element and the protected element in relief having two facing axially outer lateral faces and defining an incision having a depth substantially equal to the depth H, wherein the protective element is connected to the protected element by a plurality of rubber connecting bridges connecting the facing lateral faces of said elements.

2- The tread according to claim 1 wherein the plurality of rubber connecting bridges are regularly distributed in the longitudinal direction of the tread.

3- The tread according to claim 1 wherein the rubber connecting bridges extend in the direction of the depth over at least 40% of the depth of the incision between the protective element and the protected element.

4- The tread according to claim 1 wherein the connecting bridges extend from the contact surface of the protective element to the bottom of the incision separating the protective element from the protected element, the spaces between said bridges forming wells of average length D and of average width d, the length D being measured in the longitudinal direction of the tread and the width d being measured in the axial or transverse direction, each well having a sectional area of between 1 mm² and 10 mm².

5- The tread according to claim 4 wherein the distance L between each of the wells in the circumferential direction is between one and six times the length D and in that the width d of the wells measured in the axial direction is less than the length D.

6- The tread according to claim 4 wherein the average direction of the wells in the thickness of the tread, viewed in a meridian section plane—that is to say a plane containing the axis of rotation of the tire, forms an angle of average inclination relative to a line perpendicular to the contact surface of the protective element which is less than or equal to 25°.

7- The tread according to claim 4 wherein each well (51) comprises a widened part on at least one of the radially inner or outer ends.

8- The tread according to claim 4 wherein the wells originate at the bottom of a first part forming a longitudinal groove opening on to the contact surface of the sacrificed element and devoid of connecting bridge.

9- The tread according to claim 1 wherein a plurality of transverse channels are in addition provided within at least one protective element and opening on to an outer lateral face of said element.

10- The tread according to claim 9 wherein the channels are connected to the wells present in the protective element.
